(19) United States
(12) Patent Application Publication
(10) Pub. No.: US 2007/0074604 A1
(43) Pub. Date: Apr. 5, 2007

(54) Bottle and opener combination

(76) Inventor: Zachary Lipson, Orchard Lake, MI (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/241,691

(22) Filed: Sep. 30, 2005

(51) Int. Cl. B67B 7/16; B67B 7/44

(52) U.S. Cl. 81/3.15; 81/3.55

(57) ABSTRACT

A combination bottle and opener is disclosed. In one embodiment the opener is removably coupled to the bottle, whereas, in an alternative embodiment the opener is permanently attached to a bottle. A removable opener for a bottle comprises a hollow, cylindrical or conical tube adapted to fit over the neck of a bottle, and a bottle opener forming part of the tube. The tube may be constructed metal, plastic or other sufficiently rigid material. An integrated bottle and opener according to the invention comprises a glass bottle having a bottom, and a bottle opener forming part of the bottom. The bottle opener is constructed of the same glass used to make the bottle, or from a material different from the glass used to make the bottle, and adhered to the bottom of the bottle.

### FIELD OF THE INVENTION

This invention relates generally to bottle openers and, in particular, to a bottle opener that is either removably or permanently attached to a bottle.

### BACKGROUND OF THE INVENTION

While many bottles, including beer bottles, now include twist-off caps, some do not, particularly European and foreign beverages. Since it might be difficult on occasion to locate a bottle opener, there is a need for a more convenient apparatus and method. SUMMARY OF THE INVENTION

This invention broadly resides in a combination bottle and opener. In one embodiment the opener is removably coupled to the bottle, whereas, in an alternative embodiment the opener is permanently attached to a bottle.

A removable opener for a bottle comprises a hollow, cylindrical or conical tube adapted to fit over the neck of a bottle, and a bottle opener forming part of the tube. The tube may be constructed metal, plastic or other sufficiently rigid material.

An integrated bottle and opener according to the invention comprises a glass bottle having a bottom, and a bottle opener forming part of the bottom. The bottle opener is constructed of the same glass used to make the bottle, or from a material different from the glass used to make the bottle, and adhered to the bottom of the bottle.

### BRIEF DESCRIPTION OF THE DRAWINGS

FIG. 1 is a drawing of a preferred embodiment according to the invention;

FIG. 2 is a drawing of the embodiment of FIG. 1 in use; and

FIG. 3 is a drawing of an alternative embodiment of the invention.

### DETAILED DESCRIPTION OF THE INVENTION

Broadly, this invention combines in some form, a bottle opener along with the type of bottle that requires opening, thereby alleviating the need to find a separate opener. In one embodiment of the invention, an opener is removably affixed to a bottle, allowing it to open that bottle or others. In an alternative embodiment, the bottle itself incorporates the opener, allowing that bottle to open others.

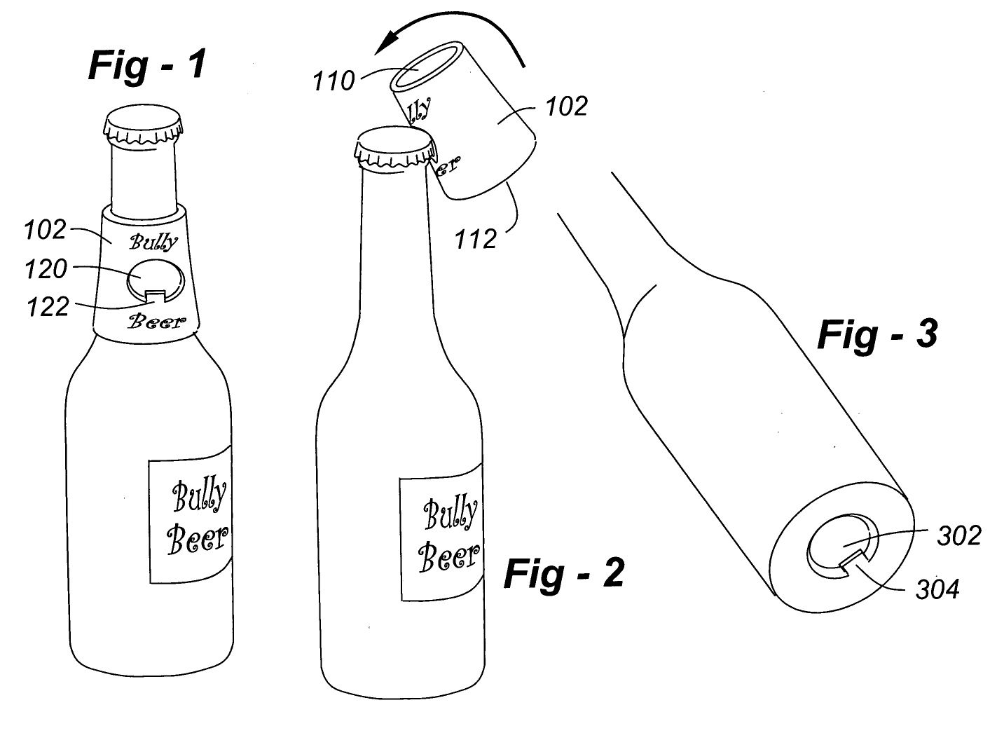

A preferred embodiment of the invention is depicted in FIG. 1, wherein an opener according to the invention 102 fits over the neck of a bottle. The device, which is constructed from metal, plastic, or other suitably strong, rigid material, includes a bottle opener formed from an aperture 120 and lip 122. Such a configuration may be used to open the cap of a bottle through a prying action, as shown in FIG. 2.

Although device 102 is preferably conical in shape to fit over the neck of the bottle in a low-profile fashion, this is not necessary to the invention. Nor is the exact geometry of the opening 120 and/or lip 122. Broadly, any device such as device 102 which fits over the neck or a portion of the bottle and contains an integral opener should be considered anticipated by this embodiment of the invention. For example, the aperture 120 need not go all the way through the wall of the device 102, so long as a bottle may be opened using the physical configuration. The device may incorporate information or advertising material, as shown in FIG. 1.

FIG. 3 is a drawing which shows an alternative embodiment of the invention, including an opener situated at the bottom of a bottle. In this case the opener preferable includes a recess 302 and some sort of lip 304, allowing the bottom of the bottle shown to be used to open the cap of another bottle through a prying action similar to that depicted in FIG. 2. The opener of FIG. 3 may be constructed out of the same glass used to make the bottle, or, to prevent chipping, a metal or plastic bottom portion including the opener may be adhered to the bottom of the bottle. Again, the exact geometry of the recess 302 and lip 304 is not essential to the invention, as long as an integral opener may be used to open a cap.

1. An opener for a bottle having a neck and a bottom, comprising:
a hollow, cylindrical or conical tube adapted to fit over the neck of a bottle; and
a bottle opener forming part of the tube.

2. The opener of claim 1, wherein the tube is constructed of metal or plastic.

3. An opener for a bottle having a neck and a bottom, comprising:
a plate affixed to the bottom of a bottle; and
a bottle opener forming part of the plate.

4. The opener of claim 3, wherein the plate is constructed of metal or plastic.

5. An integrated bottle and opener, comprising:
a glass bottle having a bottom; and
a bottle opener forming part of the bottom.

6. The integrated bottle and opener of claim 5, wherein the bottle opener is constructed of the same glass used to make the bottle.

7. The opener of claim 3 wherein the opener is constructed from a material different from the glass used to make the bottle, and is adhered to the bottom of the bottle.

8. The opener of claim 7, wherein the opener is constructed of metal or plastic.
